(19) United States
(12) Patent Application Publication
(10) Pub. No.: US 2012/0084325 A1
(43) Pub. Date: Apr. 5, 2012

(54) MASTER DATA MANAGEMENT HIERARCHY MERGING

(75) Inventors: NEELESH V. BANSODE, Bangalore (IN); THOMAS K. RYAN, Valley Center, CA (US); LATESH PANT, Bangalore (IN); ACHAL P. PATEL, Bangalore (IN)

(73) Assignee: TERADATA US, INC., Miamisburg, OH (US)

(21) Appl. No.: 13/250,761

(22) Filed: Sep. 30, 2011

Related U.S. Application Data
(60) Provisional application No. 61/388,376, filed on Sep. 30, 2010.

(51) Int. Cl. G06F 7/00

(52) U.S. Cl. 707/792; 707/E17.005

(57) ABSTRACT

A method, system, apparatus, and article of manufacture is configured to merge hierarchies in a computer system. A relational database management system (RDBMS) stores information in the computer system. As part of a process and framework, a series of business rules and process workflows that manage data (that is hierarchical in nature) that resides in one or more RDBMS tables are maintained. A first and second hierarchy table are obtained/defined. A placeholder column that will contain mapping information may be defined with the database schema. User input is accepted that identifies data in the second table that maps to data in the first table. Based on the user input, the data in the second table is mapped to the data in the first table. The mapping is utilized to create a merged hierarchy in RDBMS.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 61/388,376, filed Sep. 30, 2010, by Neelesh V. Bansode, Thomas K. Ryan, Latesh Pant, and Achal P. Patel, entitled “Master Data Management Hierarchy Merging,” attorneys' docket number 20609 (30145.477-US-P1).

This application is related to the following co-pending and commonly-assigned patent application, which application is incorporated by reference herein:

U.S. patent application Ser. No. 12/574,509, entitled “HIERARCHY MANAGER FOR MASTER DATA MANAGEMENT”, by Brian J. Wasserman, Thomas K. Ryan, Carl L. Christofferson, Neelesh V. Bansode, Santosh Kumar Singh, Madhavi Chandrashekar, and Vivek Shandilya, Attorney Docket No. 20001 (30145.467-US-U1), filed on Oct. 6, 2009, which application claims priority to Provisional Application Ser. No. 61/195,321, filed Oct. 6, 2008, Brian J. Wasserman, Thomas K. Ryan, Carl Christofferson, Neelesh V. Bansode, Santosh Kumar Singh, Madhavi Chandrashekar, and Vivek Shandilya, entitled “Hierarchy Manager for Master Data Management,” attorneys' docket number 20001 (30145.467-US-U1).

### BACKGROUND OF THE INVENTION

1. Field of the Invention

This invention relates in general to managing business critical data in a computer, and in particular, to maintaining and merging different versions of hierarchical data.

2. Description of Related Art

Master Data Management™ (MDM), available from the assignee of the present invention, is an application that allows users to manage their business critical data. This critical data can originate from a myriad of sources and external feeds, but ultimately, the goal is that all of this data be consolidated into a central business data warehouse. Master Data Management™ is the process and framework for maintaining a series of business rules and process workflows that will manage this data as it feeds in from multiple sources. Master Data Management™ then applies these business rules and process workflows to produce “master” data, which is then fed to all consuming business processes.

Part of the business critical master data consists of data that is hierarchical in nature. This data resides in a series of relational database tables that are part of the core master data. The data in these tables is hierarchical in nature, meaning that the data consists of parent-child relationships, generally represented through primary key—foreign key relationships in the underlying data.

A common requirement for customers in a master data management context is the ability to manage and manipulate this hierarchical data (i.e., the hierarchies based on the master data). The hierarchies are a logical alignment of various levels of a particular entity or a combination of entities. Generally, for most enterprise reporting needs, the facts are aggregated for a particular dimension or a combination of dimensions, rolled up/down as per a particular dimension or a combination of dimension hierarchies (e.g., a typical business logic reporting schema design of star/snowflake type).

Most of the times, in a large enterprise, the spread of the enterprise across geographical areas or across business lines invariably leads to multiple variants of the corporate/master hierarchy. The individual regions or business lines can continue to operate with their variant while the corporate or master hierarchy would need information as per its “golden” structure. This creates a need for manual merging/mapping/splitting of the hierarchies.

In one exemplary use case, a company with global operations has a corporate master hierarchy with individual operations in different countries having their own regional variants of the global hierarchy to suit their business needs. This use case can be extended to various other scenarios that may involve business lines or mergers/acquisitions, etc.

Prior art systems fail to provide the ability to manage and merge various regional hierarchies to a corporate hierarchy. Thus, prior art master data management systems fail to provide the ability to maintain and merge multiple versions of hierarchical data across an entire enterprise.

### SUMMARY OF THE INVENTION

Embodiments of the invention provide for the merging, splitting, and mapping of hierarchies within the MDM framework. In a first embodiment, hierarchies can be merged using MDM's cross reference management features. Specifically, the embodiment allows users to identify data in the hierarchies that map to data in desired corresponding hierarchies. This data is mapped according to the user input by creating cross reference relationships which are subsequently used to merge and split the hierarchies as desired by the user.

In a second embodiment, hierarchies can be merged using a standalone hierarchy with a “data mapping” solution. Specifically, a placeholder column is defined in a hierarchy as the schema for that hierarchy is defined. The placeholder column maps data in the hierarchy to data in a desired corresponding hierarchy, which allows for the merging and splitting of hierarchies as desired.

### BRIEF DESCRIPTION OF THE DRAWINGS

Referring now to the drawings in which like reference numbers represent corresponding parts throughout:

FIG. 1 illustrates an exemplary hardware and software environment according to the preferred embodiment of the present invention;

FIG. 2 illustrates the architecture of a hierarchy manager in accordance with one or more embodiments of the invention;

FIG. 3A illustrates hierarchical levels for a regional US product in accordance with one or more embodiments of the invention;

FIG. 3B illustrates hierarchical levels for a regional UK product in accordance with one or more embodiments of the invention;

FIG. 3C illustrates hierarchical levels for a global hierarchy in accordance with one or more embodiments of the invention;

FIG. 4 illustrates mappings between local (FIGS. 3A and 3B) and global (FIG. 3C) departments in accordance with one or more embodiments of the invention;

FIG. 5 illustrates a graphical user interface used to manage selected relational objects and their details as part of the RO creation process in accordance with one or more embodiments of the invention;

FIG. 6 illustrates a graphical user interface used to manage data relationships (i.e., the ROMs) in accordance with one or more embodiments of the invention;

FIG. 7 illustrates five (5) hierarchies that have been created in accordance with one or more embodiments of the invention;

FIG. 8 illustrates a global hierarchy view in accordance with one or more embodiments of the invention;

FIG. 9 illustrates a product hierarchy-US view in accordance with one or more embodiments of the invention;

FIG. 10 illustrates a product hierarchy-UK view in accordance with one or more embodiments of the invention;

FIG. 11 illustrates a product hierarchy-US merged with a global view in accordance with one or more embodiments of the invention;

FIG. 12 illustrates a product hierarchy-UK merged with a global view in accordance with one or more embodiments of the invention;

FIG. 13A illustrates a regional hierarchy perspective of sales values based on sales rolled up to a day/department US in accordance with one or more embodiments of the invention;

FIG. 13B illustrates global hierarchy perspective or sales values based on sales rolled up to a day/department US in accordance with one or more embodiments of the invention;

FIG. 14 is a flow chart illustrating the logical flow for merging two hierarchies under the first approach in accordance with one or more embodiments of the invention; and

FIG. 15 is a flow chart illustrating the logical flow for merging two hierarchies under the second approach in accordance with one or more embodiments of the invention.

### DETAILED DESCRIPTION OF THE PREFERRED EMBODIMENT

In the following description of the preferred embodiment, reference is made to the accompanying drawings, which form a part hereof, and in which is shown by way of illustration a specific embodiment in which the invention may be practiced. It is to be understood that other embodiments may be utilized and structural changes may be made without departing from the scope of the present invention.

### Overview

In MDM, hierarchy master data and its associated relationship data reside in relational tables within the product. If an organization has a need to separate hierarchies across regions, MDM users can do that by defining their relationship data separately. Now, when corporate users want to generate reports based on regional hierarchy information, they would have to merge the regional hierarchies to the corporate hierarchy. The first step that is part of such a merger is to map the nodes from the regional hierarchy to the corporate hierarchy.

This can be done in two ways with MDM:
1. Using a cross referencing capability and integrating the cross reference with the hierarchy feature.
2. Stand alone hierarchy with a “data mapping” solution.

Embodiments of the invention therefore provide the ability for multiple hierarchies to be merged and split with a corporate or master hierarchy. In addition, users are able to generate viewable reports based on merged/split hierarchies.

### Framework/Workflow Overview

In a Master Data Management (MDM) Framework, all the master data is accessed only by MDM sanctioned data processes, also called “workflows”. These workflows are central to the concept of having master data, as they become the only means by which the underlying core data can be modified. Essentially, all inbound data passes through one or more workflows that can perform the following actions on the inbound data:
Perform data quality checks;
Perform data validation;
Perform data transformations (or cleanup of data);
Identify errors in the underlying data and notify the data steward of these issues; and
Migrate data into the Master or “Gold” copy of the data, where it resides in a protected manner.

### Hardware and Software Environment Overview

Master data (sometimes referred to as reference data) are facts that define a business entity, facts that may be used to model one or more definitions or view of an entity. Entity definitions based on master data provide business consistency and data integrity when multiple systems across an organization (or beyond) identify the same entity differently (e.g., in differing data models).

Business entities modeled via master data are usually customer, product, or finance. However, master data can define any entity, like employee, supplier, location, asset, claim, policy, patient, citizen, chart of accounts, etc.

A system of record is often created or selected (also referred to as a trusted source) as a central, authenticated master copy from which entity definitions (and physical data) are propagated among all systems integrated via a Master Data Management™ (MDM) framework.

The system of record can take many forms. Many users build a central database (e.g. a data warehouse or operational data store) as a hub through which master data, metadata, and physical data are synchronized. Some hubs are simply master files or tables that collect and collate records.

Regardless of the technology approach, embodiments of the invention provide the ability to deploy a system on any designated target system for testing or production.

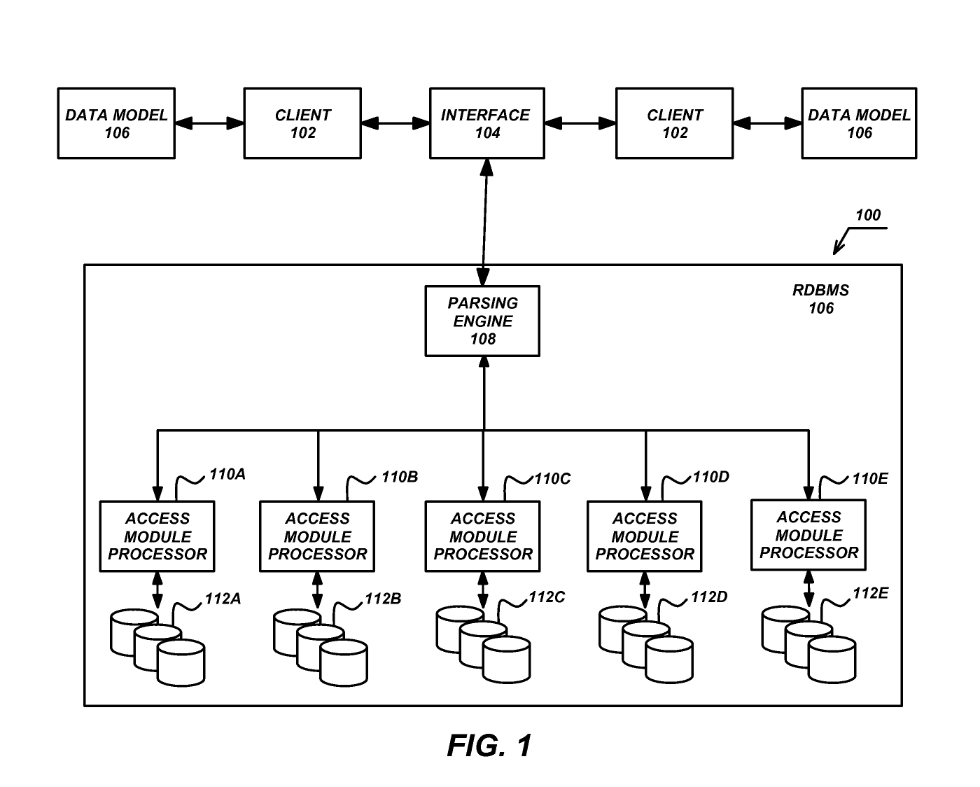

FIG. 1 illustrates an exemplary hardware and software environment according to the preferred embodiment of the present invention. In the exemplary environment, a computer system 100 implements an improved MDM framework 100, in a three-tier client-server architecture, wherein the first or client tier provides clients 102 that may include, inter alia, a graphical user interface (GUI), the second or middle tier provides an interface 104 for performing functions and interfacing with a central database or data warehouse as described later in this application, and the third or server tier comprises the central database or data warehouse (also referred to as a Relational DataBase Management System (RDBMS) 106) that stores data and metadata in a relational database. Such an RDBMS 106 is utilized to store the master data and provide a standard format within framework 100 for the master data. The first, second, and third tiers may be implemented in separate machines, or may be implemented as separate or related processes in a single machine.

In the preferred embodiment, the RDBMS 106 includes at least one parsing engine (PE) 108 and one or more access module processors (AMPs) 110A-110E storing the relational database in one or more data storage devices 112A-112E. The parsing engine 108 and access module processors 110 may be implemented in separate machines, or may be implemented as separate or related processes in a single machine. The RDBMS 106 used in the preferred embodiment comprises the Teradata® RDBMS sold by Teradata™ US, Inc., the assignee of the present invention, although other DBMS's could be used. In this regard, Teradata® RDBMS is a hardware and software based data warehousing and analytic application/database system.

Generally, clients 102 include a graphical user interface (GUI) for operators or users of the system 100, wherein requests are transmitted to the interface 104 to access data stored in the RDBMS 106, and responses are received therefrom. In response to the requests, the interface 104 performs the functions described below, including formulating queries for the RDBMS 106 and processing data retrieved from the RDBMS 106. Moreover, the results from the functions performed by the interface 104 may be provided directly to clients 102 or may be provided to the RDBMS 106 for storing into the relational database. Once stored in the relational database, the results from the functions performed by the interface 104 may be retrieved more expeditiously from the RDBMS 106 via the interface 104. Further, each client 102 may have other data models 106.

Note that clients 102, interface 104, and RDBMS 106 may be implemented in separate machines, or may be implemented as separate or related processes in a single machine. Moreover, in one or more embodiments, the system 100 may use any number of different parallelism mechanisms to take advantage of the parallelism offered by the multiple tier architecture, the client-server structure of the client 102, interface 104, and RDBMS 106, and the multiple access module processors 110 of the RDBMS 106. Further, data within the relational database may be partitioned across multiple data storage devices 112 to provide additional parallelism.

Generally, the clients 102, interface 104, RDBMS 106, parsing engine 108, and/or access module processors 110A-110E comprise logic and/or data tangibly embodied in and/or accessible from a device, media, carrier, or signal, such as RAM, ROM, one or more of the data storage devices 112A-112E, and/or a remote system or device communicating with the computer system 100 via one or more data communications devices. The above elements 102-112 and/or operating instructions may also be tangibly embodied in memory and/or data communications devices, thereby making a computer program product or article of manufacture according to the invention. As such, the terms “article of manufacture,” “program storage device” and “computer program product” as used herein are intended to encompass a computer program accessible from any computer readable device or media. Accordingly, such articles of manufacture are readable by a computer and embody at least one program of instructions executable by a computer to perform various method steps of the invention.

However, those skilled in the art will recognize that the exemplary environment illustrated in FIG. 1 is not intended to limit the present invention. Indeed, those skilled in the art will recognize that other alternative environments may be used without departing from the scope of the present invention. In addition, it should be understood that the present invention may also apply to components other than those disclosed herein.

### Hardware and Software Environment Details

As described above with respect to FIG. 1, the master data is stored in RDBMS 106 and is accessed by clients 102 via interface 104. Such client 102 access through interface 104 is enabled by MDM sanctioned data processes referred to as workflows (e.g., provided in interface 104). Rather than being provided via interface 104, such workflows may be provided as part of parsing engine 108 or be provided by the AMPs 110 (or other parts of RDBMS 106). Consumer applications and processes may execute on clients 102 and may need to receive data from the RDBMS 106.

As described herein, the interface 104 to the data may provide a hierarchy manager or hierarchy viewer that provides the ability for users to access, visualize, manage and manipulate the hierarchy data stored in the RDBMS 106.

### Hierarchy Management

Overview

A hierarchy manager is a feature to MDM that allows users to define a hierarchy structure that effectively mirrors the hierarchical nature of their data. This hierarchy structure can then be used to drive a hierarchy viewer and drive reporting processes.

Accordingly, the hierarchy manager provides the ability to define/manage the composition of a hierarchy. This includes the ability to add/delete/modify dimensions, add hierarchies to dimensions, delete hierarchies from dimensions, modify hierarchy information (i.e., name/description), add/modify/delete hierarchy objects, and add/modify/delete hierarchy relationships. Hierarchy management further provides at least two (2) layers of role-based access including a data steward/admin (to make modifications to the structure/composition of the hierarchy and an access layer (to limit access to only view the composition of the hierarchy [e.g., without the option to make changes]). A hierarchy definition (e.g., the hierarchy structure, meaning hierarchy objects and relationships) may be imported from a predefined spreadsheet template. Further, data permissions may be established such that certain users may have privileges (or not have privileges) to see certain categories of data.

As part of the hierarchy management, a data steward may have the ability to explicitly create a version of a hierarchy. Users may be provided with the ability to view earlier versions of a hierarchy, the ability to view data associated with an earlier version of a hierarchy (e.g., if it was archived), the ability to restore an older version of a hierarchy, and the ability to delete old versions. Such versioning capability effectively snapshots the definition of a hierarchy expressed in metadata, for historical purposes. Accordingly, users can choose to snapshot hierarchy data at any point in time (e.g., for later historical comparisons).

Hierarchy Definition and Nomenclature

In an MDM context, a hierarchy is a set of business data (e.g., in the RDBMS 106) that can be organized into a hierarchical structure. The MDM “Hierarchy” captures these data relationships into a formal structure that can be used throughout the enterprise 100. In an MDM context, a hierarchy will always point to data contained in the MDM master database (e.g., RDBMS 106). This means that the member data contained in fact tables that comprise a hierarchy is already under management of various MDM workflows and business processes.

A hierarchy consists of the following components:

1. Dimensions—The purpose of a dimension is simply to organize hierarchies into functional areas, such as “CUSTOMER” or “PRODUCT” hierarchies. A single dimension can hold multiple hierarchies.

2. Hierarchy—This is a definition of the data relationships for hierarchical data. Hierarchical data is also known as hierarchy objects, since each data member represents an object that is used for business purposes. The data relationships are referred to as hierarchy relationships, as this denotes how hierarchy objects relate to one another.

3. Hierarchy Objects—A hierarchy object will point to a table in the master database that will contain the actual member data. For example, a hierarchy object of “Customer” will point to the “Customer” table in the master database.

4. Hierarchy Relationships—This formalizes the data relationships between hierarchy objects into the hierarchy, so that it can be used to drive other enterprise processes. As an example, if there are two hierarchy objects: “CUSTOMER” and “HOUSEHOLD”, and customers may belong to a household, the data relationship that maps a CUSTOMER to a HOUSEHOLD is represented by the hierarchy relationship “CUSTOMER TO HOUSEHOLD”. A hierarchy relationship will always be a primary-to-foreign key relationship in the database.

Architecture

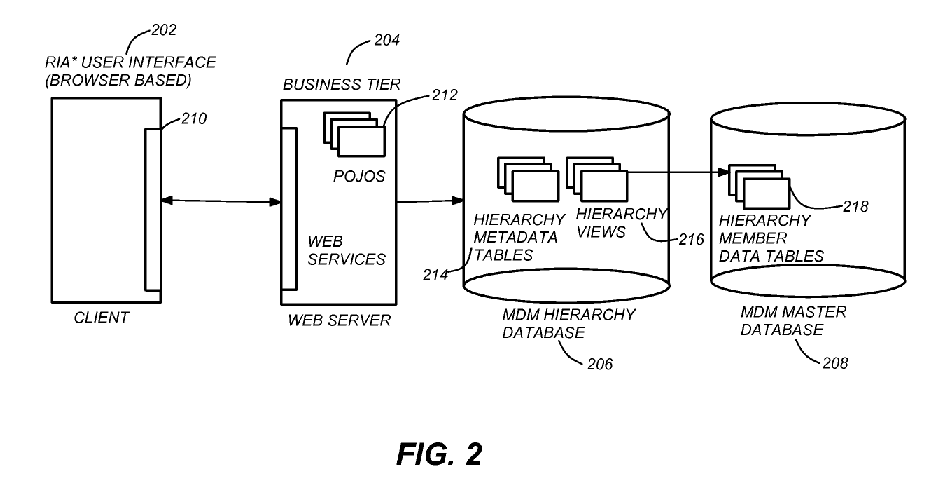

FIG. 2 illustrates the architecture of a hierarchy manager in accordance with one or more embodiments of the invention. Essentially, the hierarchy will consist of the following components: a user interface 202, a business tier 204, an MDM hierarchy database 206, and the MDM master database 208.

The user interface 202 may be coded in Adobe™ Flex 2 (MXML and ActionScript 3.0™). There will be a thin business delegate layer 210 (and supporting data transfer (or value) objects), that serves to separate the business tier 204 logic from the remainder of the presentation logic 202. This business delegate 210 may be written in ActionScript™.

The business tier 204 resides on the web server, and consist of POJOs (plain old java objects) 212 that handle the majority of the business tier 204 processing. The POJOs 212 are wrapped by a thin web service layer.

The MDM Hierarchy Database 206 is a database that holds metadata tables 214, hierarchy views 216, and version archives. Metadata tables 214 hold metadata about the hierarchies. This includes info about the dimensions, hierarchies, hierarchy objects, and hierarchy relationships. Hierarchy views 216 are the primitive database views that map directly to a corresponding table in the MDM master database 208. Version archives (not pictured) are the historical archives of hierarchy versions, and potentially archives of the member data.

The MDM master database 208 contains the MDM master tables 218, that contain the member data of the hierarchy objects, as well as the relationships to other hierarchy objects. The hierarchy manager may always read and write through the primitive views that exist in the hierarchy database 206. It does not read/write directly to the master database 208. However, since the master database 208 contains the master data, it is shown for completeness.

As illustrated in FIG. 2, the business logic (e.g., in business tier 204) should be separated from the presentation logic (e.g., in the UI 202). The Flex™ based UI 202 invokes functions or services that reside on the web server (e.g., either as Web Services or POJOs 212). Access to the business functionality may be “wrapped” in a business delegate class (or classes). The UI 202 may also generate custom ActionScript classes and components wherever necessary. In this regard, most of the hierarchy user interface 202 may rely on dynamically generated user interface objects (e.g., ActionScript based components).

The user interface 202 may also be “skinned” as necessary, so that the appearance of all objects can be specified through a cascading style sheet (.css). In this regard, the appearance may be configured to look and feel similar to other user interfaces. Further, the Flex™-based user interface and all end-user text, prompts, tool-tips, and error messages may be globalized. In addition to the above, the user interface 202 may provide the following abilities: show dimensions; add/modify/delete dimensions; add hierarchies to a dimension; delete a hierarchy from a dimension; edit the structure/composition of a hierarchy; add a hierarchy object; modify a hierarchy object; delete a hierarchy object; edit a hierarchy; add a relationship between hierarchy objects (hierarchy relationships); add/modify/delete hierarchy relationships; and the ability for users to explicitly create a new version of the hierarchy.

The business tier (204) (webserver/J2EE tier) functionality consists of Java™-based functionality that will reside on the MDM web server. All of the Java™-based functionality may be contained in one or more POJOs 212, and be accompanied by any necessary value (or data transfer) objects. The reason for encapsulating the core functionality in POJOs 212 is that this allows one to ‘wrap’ the functionality with a very thin layer, either via a web service layer, or by a business delegate class. One POJO 212 may be utilized per functional area (e.g., a POJO 212 to handle dimension functionality, one for hierarchy, one for hierarchy object, etc.). The layer wrapping the POJOs 212 may be very thin such that no business functionality is present (such functionality may reside in the POJOs 212). Errors occurring on the server may also be logged. Further, error messages (and other interfaces shown to the user) may be stored in resource bundles.

The business tier 204 may provide the following functions: get/add/delete dimensions from dimension metadata tables; add/delete, get hierarchies for a specific dimension; add/delete a hierarchy object to/from a hierarchy; change the sequence/order of a hierarchy object (may act on multiple hierarchy objects simultaneously); add/delete/modify a hierarchy object from one or more databases; add/delete/modify a hierarchy relationship (e.g., mappings); various Xdocument related functionality including returning data based on a master database definition of a table (e.g., retrieving database and table names, retrieving table columns [primary key or otherwise], validating mappings to ensure unique mappings and proper datatype alignment, etc.). For the hierarchy viewer, business tier 204 functionality may utilize methods in the hierarchy manager, to retrieve (and possibly cache) the hierarchy metadata for a specified hierarchy. Specifically, there may be a single call to retrieve version xxx of a specific hierarchy—this will return a structure containing all of the metadata. This may be passed back to subsequent business methods, to avoid repeatedly looking up this info in the database 206 or 208). Further, additional business methods may be used to retrieve the child data for a specific parent data element (identified with Primary Key info). This business method will form the correct SQL against the views in the MDM Hierarchy database 206 to retrieve the hierarchy data and return it back to the Flex™ client in the user interface 202. In addition, a change parent method in the business tier 204 may be called when the user drags an element from one parent node to another—effectively changing the data in the underlying database.

Metadata defines the various tables to be used to store the data. For example, a dimension table defines a dimension, a hierarchy table defines a hierarchy that belongs to a specific dimension, a hierarchy version contains information about each version of the hierarchy, a hierarchy object table defines a hierarchy object, a hierarchy-to-object mapping table supports the ability to use a hierarchy object in multiple hierarchies, a hierarchy relationship table contains hierarchy relationships (that captures data mappings a PK to FK relationship in the data), and a hierarchy relationship map table maps the primary keys in a parent object to a foreign key in a child object.

### Hierarchy Viewer

As described above, the hierarchy viewer provides the ability to visually view and interact with hierarchical data. Accordingly, the viewer is a data visualization feature that allows users to visualize their business critical hierarchical data (e.g., in a visual hierarchy). To utilize the viewer, users select a dimension and hierarchy that results in the display of all top-level member data (from the selected hierarchy).

Referring to FIG. 2, the hierarchy viewer uses the hierarchy metadata to dynamically build SQL (structured query language) statements that fetch data from the hierarchy database 206. The viewer then displays this data in a graphical layout (e.g., in user interface 202), and allows users to directly interact with the hierarchy.

### Hierarchy Merging

Overview

The master data and the relationship data reside in a series of MDM tables that are part of the core of master data management. Management and manipulation of relationship data is provided within MDM in the form of user interfaces, hierarchies, and business workflows capabilities.

In MDM, the hierarchy master data and its associated relationship data reside in relational tables within the product. If an organization has a need to separate hierarchies across regions, MDM users can do that by defining their relationship data separately. Now, when corporate users want to generate reports based on regional hierarchy information, they would have to merge the regional hierarchies to the corporate hierarchy. The first step that is part of such a merger is to map the nodes from the regional hierarchy to the corporate hierarchy.

This can be done in two ways with MDM:
1. Using a cross referencing capability and integrating the cross reference with the hierarchy feature.
2. Stand alone hierarchy with a “data mapping” solution.

In the first approach, an entity from a regional hierarchy can be mapped to a golden record in the corporate hierarchy using MDM's cross reference management features. MDM provides metadata driven user interfaces (UIs) to pick up tables and map the data from those tables to a golden record in the master table. This cross reference data can be used to merge and split the hierarchies as required. Since the data resides in relational tables in Teradata, business logic tools can re-use the same information for generating reports.

In the second approach, the regional master tables can have placeholder columns that indicate what golden record in the corporate master table it would map to. Here again, since the data resides in MDM master tables 208 (or alternatively in the hierarchy database 206), the same advantages as explained in the first approach can be carried forward. Although this approach is simpler, it would require upfront schema design to accommodate the cross reference information. The first approach would allow customers to define relationships and cross-references at run-time.

Embodiments of the invention therefore provide the ability for multiple hierarchies to be merged and split with a corporate or master hierarchy. Also with the default hierarchy management and relationship management screens, users can view, visualize, and interact with the same hierarchy under separate perspectives, regional and corporate, while allowing this data remain under the control of the Master Data Management framework. Thus, embodiments of the invention add significant new capabilities to the prior art MDM implementations.

Hierarchy Merger Details

To enable the ability to maintain separately created hierarchies while also enabling the reporting/analysis of all hierarchies (including merged hierarchies), a base or “golden” hierarchy is created that other hierarchies are mapped to. As described above, two different options may be used to create such a mapping. Once created, the viewing, visualizing, and interacting with individual, split, and merged hierarchies are available to users within an MDM framework/environment. An exemplary implementation is useful to better understand the invention.

One exemplary implementation is provided for a typical retailer product hierarchy case. The retailer R operates in two major geographical regions, namely the US and UK. Also, this retailer R is fairly well established with different store formats in the US region but, only as of late, has ventured into the UK region, and thus has quite a few differences in its product hierarchies across the US and UK.

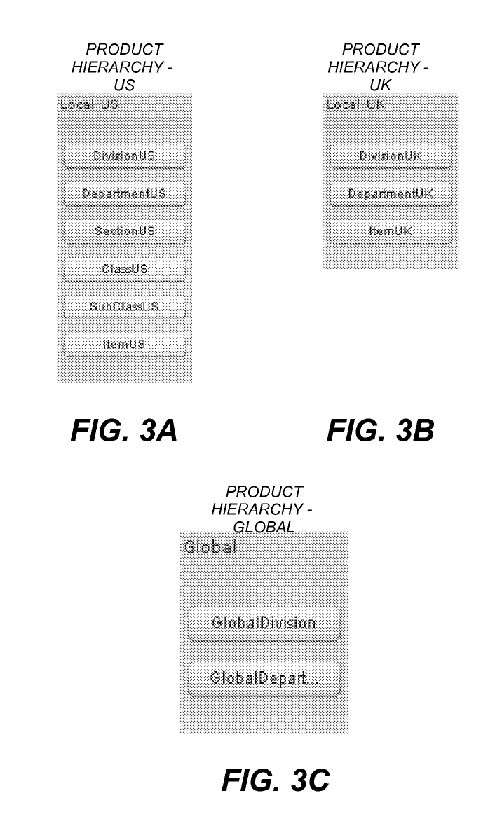

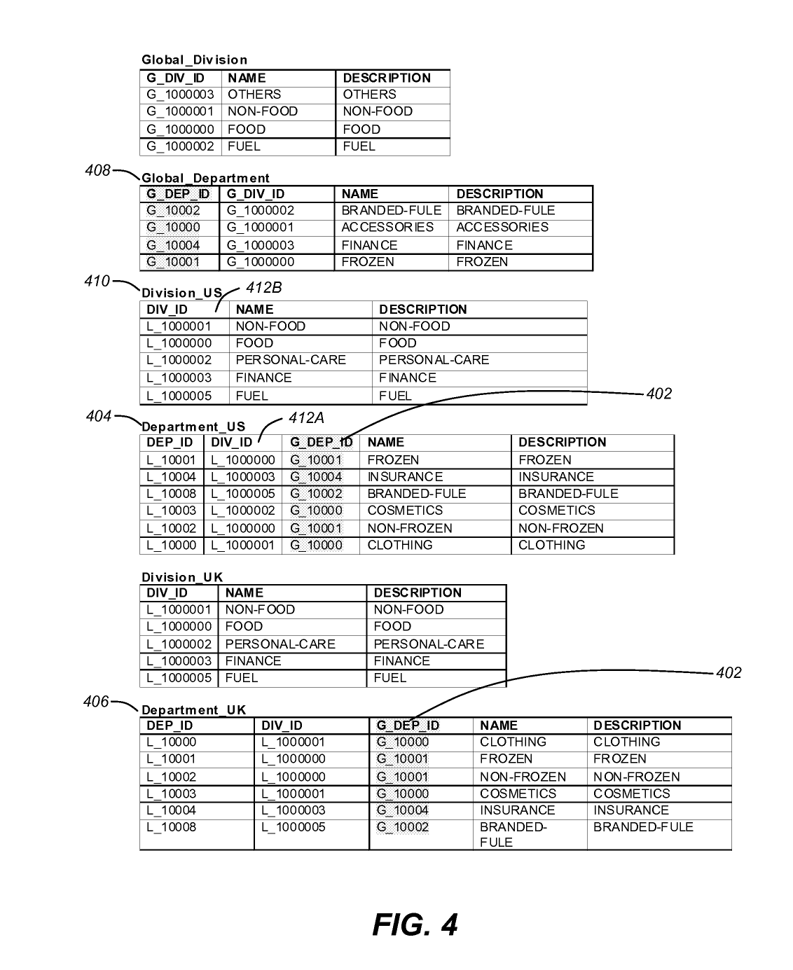

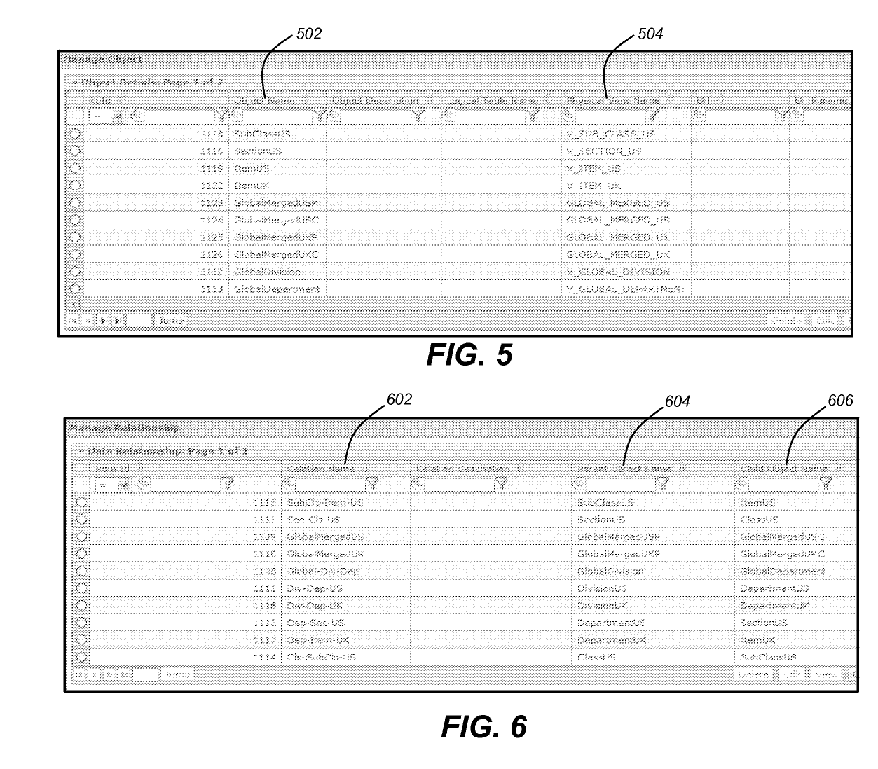

With the US region being retailer R's mature market, the US region has a very detailed product hierarchy with “ItemUS” being the lowest reported level, “SectionUS”/“ClassUS”/“SubclassUS” being the next level linked to “DepartmentUS” and “DivisionUS”, which are the top branches at the total company (All) level. The hierarchical levels for the US product is illustrated in FIG. 3A in accordance with one or more embodiments of the invention. Whereas in the UK, as depicted in FIG. 3B, retailer R just has “ItemUK,” “DepartmentUK,” “DivisionUK,” and total company (All) forming the product hierarchy.

If the top management of retailer R decides to have a corporate global view (global) of their product hierarchies across regions and they also decide that the global product hierarchy should just have two levels, namely “GlobalDivision” and “GlobalDepartment,” it would be depicted as shown in FIG. 3C.

The key principle here is to map each of the local nodes (e.g., of FIG. 3A or FIG. 3B), at an equivalent or otherwise hierarchical level, to the global corporate hierarchy (e.g., of FIG. 3C). The maintenance would be a lot easier if the mappings are done between the equivalent hierarchical nodes (e.g., from equivalent hierarchical levels) but it is not mandatory that the mappings have to be done at the equivalent nodes (e.g., hierarchical level nodes). The mappings can also be done between any local node to an appropriate global corporate hierarchical node.

FIG. 4 illustrates mappings between local (FIGS. 3A and 3B) and global (FIG. 3C) departments in accordance with one or more embodiments of the invention. As illustrated, the G_DEP_ID 402 of both the US Department 404 and UK Department 406 are used as keys to map to the Gobal Department 408. The primary key of the Global Department 408 is the G_DEP_ID while multiple different departments can map to the same global department ID in the US Department 404 and/or UK department 406.

All of these mappings can be done within the MDM framework/system. The hierarchy manager/relationship manager can be used to create various relationships and hierarchies, including merged hierarchies. A merged hierarchy combines both the global and local hierarchies into one hierarchy seamlessly. As described above, the mappings need to be created, and at least two methods may be used to perform such a mapping. In the first method, cross-referencing capabilities are used and the relationship/mapping data may be stored in a relationship table. In the second method, a placeholder column is added to each local table that identifies the global master table that it maps to.

Once the mapping has been completed, it may be desirable to view/generate a report for either the individual local hierarchies or a merged/joint hierarchy. For example, a business may wish to see a detailed US product hierarchy with respect to the global hierarchy (global divisions and global departments). This can be done by selecting the global keys in addition to the local keys 402 while defining the hierarchy and its various components. The following description illustrates how to create a hierarchy that supports such merging/reporting/viewing capabilities in accordance with one or more embodiments of the invention.

To create a hierarchy, relational objects (ROs), relational object maps (ROMs), and then hierarchies are created.

In an exemplary implementation of creating ROs, each required table such as “Division_US 410,”, “Department_US 404,” etc., as illustrated in FIG. 4, is selected and the appropriate primary/link keys 402 are chosen. The columns/details that need to be displayed on the hierarchy viewer UI are also selected. FIG. 5 illustrates a graphical user interface used to manage selected relational objects and their details as part of the RO creation process in accordance with one or more embodiments of the invention. As illustrated, the names of the objects that have been selected are identified in column 502 while the physical view name of such objects are displayed in column 504.

Once the ROs have been created, ROMs between the required ROs may be created. One example of the creation of ROMs between the required ROs is creating a relationship between “Division_US 410” and “Department_US 404” by linking the division id “DIV_ID” 412A in the “Department_US” table (foreign key) to the division id “DIV_ID” 412B in the “Division_US” table (primary key). Similarly, the global mappings and keys are used to create additional ROMs. FIG. 6 illustrates a graphical user interface used to manage data relationships (i.e., the ROMs) in accordance with one or more embodiments of the invention. As illustrated, the hierarchical levels (i.e., parent-child relationships) are established using the interface of FIG. 6. In this regard, the user can specify a name for a relationship (in column 602) and the corresponding nodes forming the relationship in columns 604 and 606.

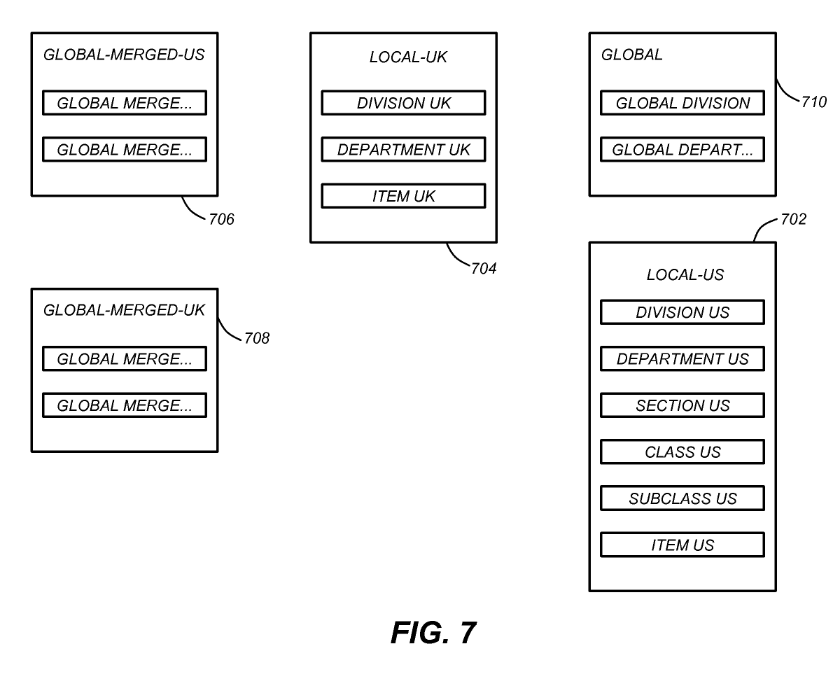

Using the just created ROMs, hierarchies can be created. FIG. 7 illustrates five (5) hierarchies that have been created, where each hierarchy represents the product hierarchies for the Local-US 702 and UK 704, Global-Merged-US 706 and UK 708, and just the Global product hierarchy 710 in accordance with one or more embodiments of the invention.

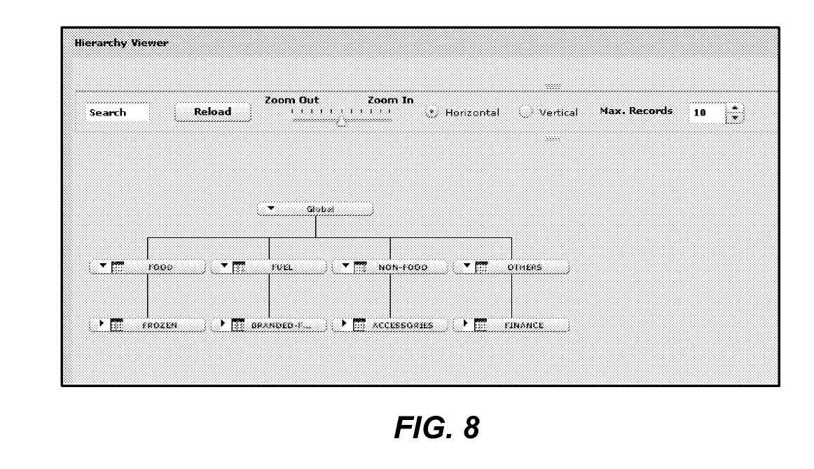

Once the hierarchies have been created, a hierarchy viewer can be used to view the different hierarchies. FIGS. 8-12 are graphical user interfaces containing various different hierarchies displayed using a hierarchy viewer in accordance with one or more embodiments of the invention.

FIG. 8 illustrates a global hierarchy view. Note that there are only two levels (division and department) defined here.

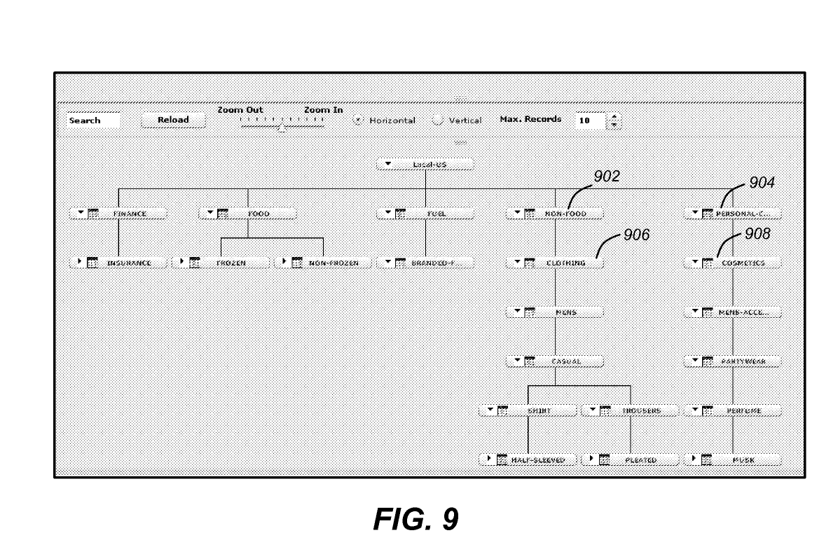

FIG. 9 illustrates a product hierarchy-US view. Note the divisions “Non-Food” 902 and “Personal-Care” 904 and its descendents; this will be useful in identifying the “merges” with the global hierarchy.

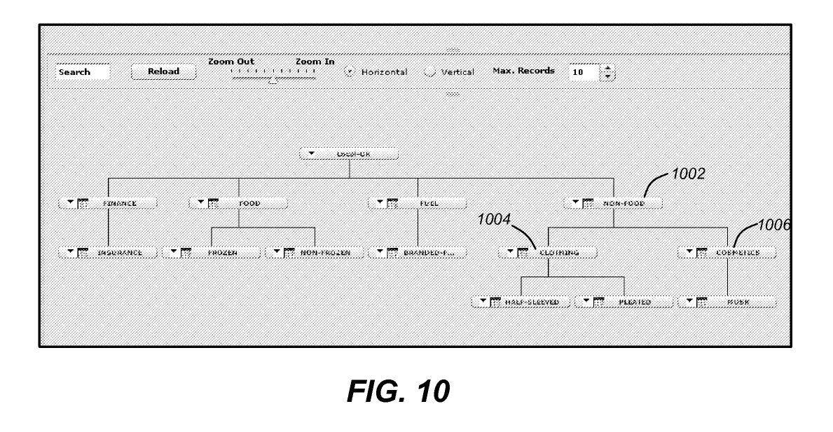

FIG. 10 illustrates a product hierarchy-UK view. Note the division “Non-Food” 1002 and its descendents; this will be useful in identifying the “merges” with the global hierarchy.

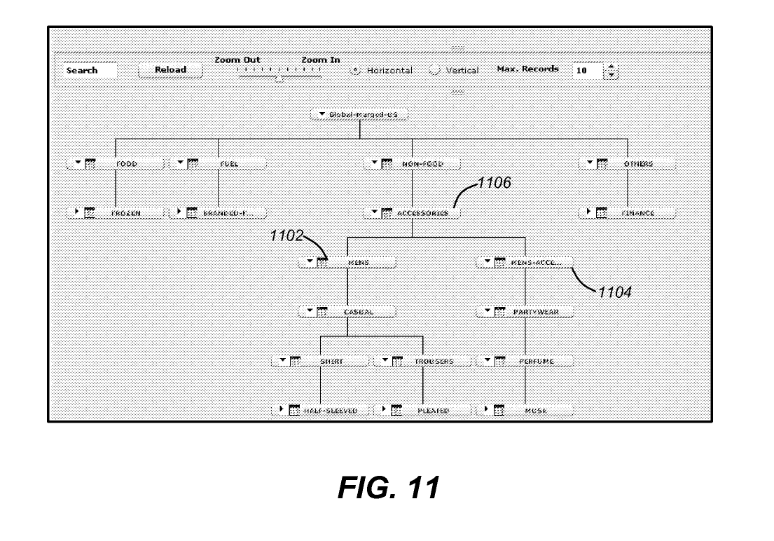

FIG. 11 illustrates a product hierarchy-US merged with a global view. When the view of FIG. 11 is compared with the product hierarchy-US view of FIG. 9, there is a difference in the sections—“Men's” 1102 and “Men's Accessories” 1104 getting merged with the global department, “Accessories” 1106, unlike the local US hierarchy, where they belong in the “Clothing” 906 and “Cosmetics” 908 departments, respectively.

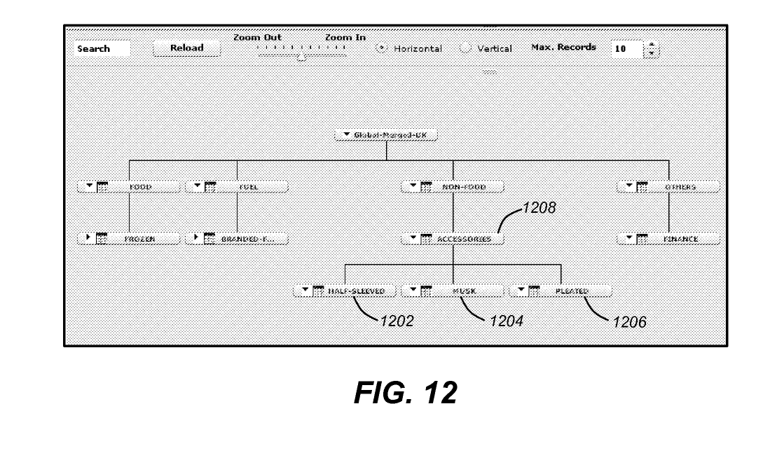

FIG. 12 illustrates a product hierarchy-UK merged with a global view. When the view of FIG. 12 is compared with the product hierarchy-UK view of FIG. 10, there is a difference in items—“Half Sleeved” 1202, “Musk” 1204, and “Pleated” 1206 are under global department, “Accessories” 1208, but actually they belong in the “Clothing” 1004 and “Cosmetics” 1006 departments. Also the local division and department, “Finance” and “Insurance” are merged into “Others” and “Finance,” respectively.

In view of the above, embodiments of the invention describes the solution/implementation for merging various region hierarchies into a global corporate hierarchy, which in turn may be used by various other enterprise applications such as Business Intelligence (BI) reporting. Hierarchies, relationships, and cross reference are basically data that is stored in master tables. Such data can typically be used directly by a BI system or fed to a system which forms the source/access layer for BI reporting.

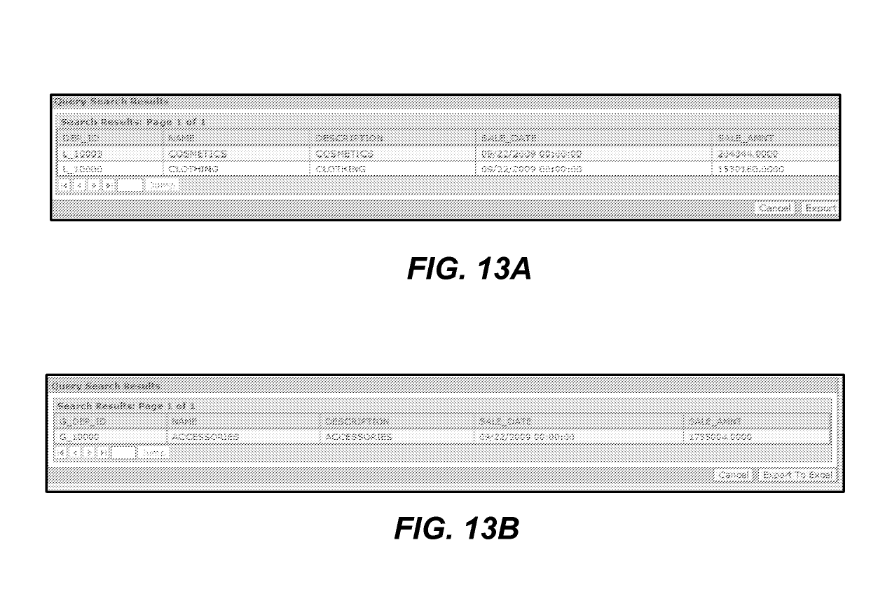

As an exemplary use of a BI system, consider a daily item sales table for the US for the same retailer, R. When the sale is rolled up to a day/department US, the sales value may appear as illustrated in FIG. 13A. As illustrated, the sales data is combined with department information to identify the relevant information in each row/tuple of data. The same fact, when viewed from a global hierarchy perspective is shown in FIG. 13B. Different dimension values may be noted between FIGS. 13A and 13B. Also the sales figure shows up as split or merged, as appropriate, from a particular hierarchy perspective. Similarly, the local and global aggregation benefits could be achieved for all local hierarchies and at various levels.

Logical Flow

As described above, a primary element needed to support different hierarchies is the ability to map data/nodes from two separately created hierarchies to each other (e.g., a regional hierarchy to a global hierarchy). Two methods may be employed to perform such a mapping.

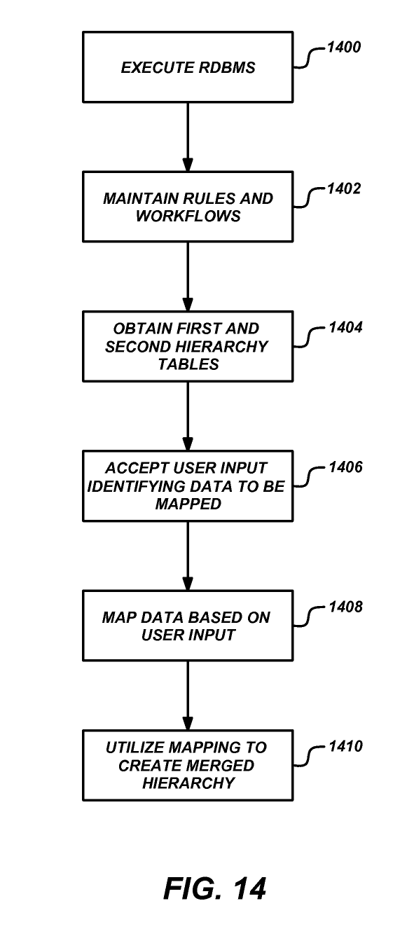

FIG. 14 is a flow chart illustrating the logical flow for merging two hierarchies under the first approach in accordance with one or more embodiments of the invention. At step 1400, a relational database management system (RDBMS) is executed/managed that stores information in a computer system.

At step 1402, as part of a process and framework, a series of business rules and process workflows (that manage data that resides in the RDBMS tables) are maintained. The data that is managed is hierarchical in nature.

At step 1404, a first hierarchy table (e.g., a master/global hierarchy table) and a second hierarchy table (e.g., individual/regional hierarchy table) based on the data are obtained via the process and framework. The first hierarchy table is defined separately from the second hierarchy table. Also, the first hierarchy table and second hierarchy table define the hierarchical nature of the data in the RDBMS. The master hierarchy may establish a base view of the individual hierarchy and have one or more base-defined hierarchical levels that are shared across the individual hierarchy and any additional individual hierarchies.

At step 1406, user input is accepted, via the process and framework, which identifies data in the second hierarchy table that maps to data in the first hierarchy table.

At step 1408, based on the user input, the data in the second hierarchy table is then mapped, via the process and framework, to the data in the first hierarchy table. To perform the mapping, one or more ROs and ROMs may be created. The ROs identify a first key from the first hierarchy table and a second key from the second hierarchy table. A first and second RO are then created based on the identified keys. The ROM is created by creating a cross-reference relationship mapping the second RO to the first RO. Such ROs and ROMs may be created at run-time of the MDM system.

At step 1410, this mapping is utilized, via the process and framework, to create a merged hierarchy in the RDBMS. Such a merged hierarchy may include a subset of data from the first and second hierarchy tables.

In addition, the merged hierarchy, ROs, and ROMs may be used to generate a user-defined report (through the series of business rules and process workflows).

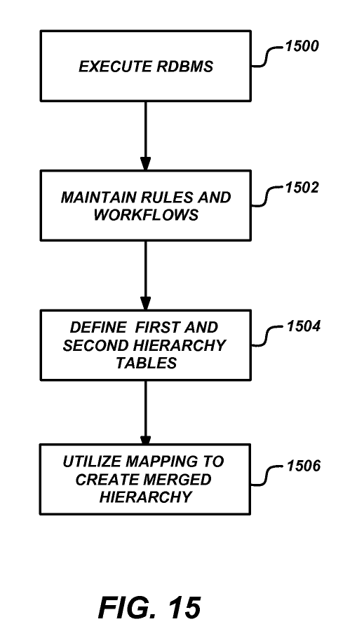

FIG. 15 is a flow chart illustrating the logical flow for merging two hierarchies under the second approach in accordance with one or more embodiments of the invention. At step 1500, a relational database management system (RDBMS) is executed/managed that stores information in a computer system.

At step 1502, as part of a process and framework, a series of business rules and process workflows (that manage data that resides in the RDBMS tables) are maintained. The data that is managed is hierarchical in nature.

At step 1504, a first hierarchy table (e.g., a master/global hierarchy table) and a second hierarchy table (e.g., a regional/local/individual hierarchy table) based on the data are defined via the process and framework. The first hierarchy table is defined separately from the second hierarchy table. Also, the first hierarchy table and second hierarchy table define the hierarchical nature of the data in the RDBMS. Furthermore, a placeholder column is defined in the second hierarchy table (e.g., in the regional/local hierarchy table). The placeholder column contains the mapping information to map the data from the second table (i.e., the regional/local data) to data in the first hierarchy table (i.e., to the global/golden record). The placeholder column may be defined when a schema for the second hierarchy table is defined. The master hierarchy may establish a base view of the individual hierarchy and have one or more base-defined hierarchical levels that are shared across the individual hierarchy and any additional individual hierarchies.

At step 1506, this mapping is utilized, via the process and framework, to create a merged hierarchy in the RDBMS. Such a merged hierarchy may include a subset of data from the first and second hierarchy tables.

Under both approaches, one or more hierarchies can be merged with another hierarchy. In one exemplary implementation, the merged hierarchy comprises subsets of data from multiple hierarchy tables. In another exemplary implementation, one or more individual hierarchies are merged with a master hierarchy. The master hierarchy comprises a base view of all the individual hierarchies having one or more base-defined hierarchical levels that are shared across all of the individual hierarchies. In a further exemplary implementation, one or more regional hierarchies are merged with a corporate global hierarchy. The corporate global hierarchy comprises a corporate global view of all the regional hierarchies having one or more corporate defined base hierarchical levels that are shared across all the regional hierarchies.

### CONCLUSION

This concludes the description of the preferred embodiment of the invention. The following paragraphs describe some alternative embodiments for accomplishing the same invention. In one alternative embodiment, any type of computer or configuration of computers could be used to implement the present invention.

The invention also allows multiple hierarchies to be merged and split with a corporate or master hierarchy, thus adding significant capabilities to the Master Data Management offering. With the default hierarchy management and relationship management screens, users can view, visualize, and interact with the same hierarchy under separate perspectives, regional and corporate, while allowing this data remain under the control of the Master Data Management framework. The merged hierarchies may be used by various other enterprise applications such as BI reporting.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for merging two hierarchies, comprising:
(a) executing a relational database management system (RDBMS) that stores information in a computer system;
(b) maintaining, as part of a process and framework, a series of business rules and process workflows to manage data that resides in one or more RDBMS tables, wherein the data is hierarchical in nature;
(c) obtaining, via the process and framework, a first hierarchy table and a second hierarchy table based on the data, wherein:
(i) the first hierarchy table is defined separately from the second hierarchy table; and
(ii) the first hierarchy table and the second hierarchy table define the hierarchical nature of the data in the RDBMS;
(d) accepting, via the process and framework, user input identifying data in the second hierarchy table that maps to data in the first hierarchy table;
(e) mapping, via the process and framework, the data in the second hierarchy table to the data in the first hierarchy table based on the user input; and
(f) utilizing, via the process and framework, the mapping to create a merged hierarchy in the RDBMS.

2. The method of claim 1 wherein the step of mapping data in the second hierarchy table to data in the first hierarchy table comprises:
(a) creating one or more relational objects (ROs) by:
(i) identifying a first key from the first hierarchy table and a second key from the second hierarchy table; and
(ii) creating a first RO based on the identified first key and a second RO based on the identified second key; and
(b) creating one or more relational object maps (ROMs) by:
(i) creating a cross-reference relationship mapping the second RO to the first RO.

3. The method of claim 2 further comprising the step of generating a user-defined report through the series of business rules and process workflows that utilize the relational objects and relational object maps.

4. The method of claim 2 further comprising the step of first executing a master data management system and wherein the relational objects and the relational object maps are created at run-time of the master data management system.

5. The method of claim 1 wherein:
the first hierarchy table is a master hierarchy and the second hierarchy is an individual hierarchy;
the master hierarchy comprises a base view of the individual hierarchy; and
the master hierarchy has one or more base-defined hierarchical levels that are shared across the individual hierarchy and any additional individual hierarchies.

6. The method of claim 1 wherein the merged hierarchy comprises a subset of data from the first hierarchy table and a subset of data from the second hierarchy table.

7. A computer-implemented method for merging two hierarchies, comprising:
(a) executing a relational database management system (RDBMS) that stores information in a computer system;
(b) maintaining, as part of a process and framework, a series of business rules and process workflows to manage data that resides in one or more RDBMS tables, wherein the data is hierarchical in nature;
(c) defining, via the process and framework, a first hierarchy table and a second hierarchy table based on the data, wherein:
(i) the first hierarchy table is defined separately from the second hierarchy table;
(ii) the first hierarchy table and the second hierarchy table define the hierarchical nature of the data in the RDBMS; and
(iii) a placeholder column is defined in the second hierarchy table, wherein the placeholder column maps data in the second hierarchy table to data in the first hierarchy table; and
(d) utilizing, via the process and framework, the mapping to create a merged hierarchy in the RDBMS.

8. The method of claim 7 wherein the placeholder column is defined when a schema for the second hierarchy table is defined.

9. The method of claim 7 wherein:
the first hierarchy table is a master hierarchy and the second hierarchy is an individual hierarchy;
the master hierarchy comprises a base view of the individual hierarchy; and
the master hierarchy has one or more base-defined hierarchical levels that are shared across the individual hierarchy and any additional individual hierarchies.

10. The method of claim 7 wherein the merged hierarchy comprises a subset of data from the first hierarchy table and a subset of data from the second hierarchy table.

11. An apparatus for merging two hierarchies, comprising:
(a) a relational database management system (RDBMS) executing in a computer system;
(b) a master data management system configured to maintain, as part of a process and framework, a series of business rules and process workflows to manage data that resides in one or more tables in the RDBMS, wherein the data is hierarchical in nature;
(c) a first hierarchy table and a second hierarchy table based on the data, wherein:
(i) the first hierarchy table is defined separately from the second hierarchy table; and
(ii) the first hierarchy table and the second hierarchy table define the hierarchical nature of the data in the RDBMS;
(d) a hierarchy manager, executing in the computer system configured to:
(i) accept, via the process and framework, user input identifying data in the second hierarchy table that maps to data in the first hierarchy table;
(ii) map, via the process and framework, the data in the second hierarchy table to the data in the first hierarchy table based on the user input; and
(iii) utilize, via the process and framework, the mapping to create a merged hierarchy in the RDBMS.

12. The apparatus of claim 11 wherein the hierarchy manager is configured to map the data in the second hierarchy table to the data in the first hierarchy table by:
(a) creating one or more relational objects (ROs) by:
(i) identifying a first key from the first hierarchy table and a second key from the second hierarchy table; and
(ii) creating a first RO based on the identified first key and a second RO based on the identified second key; and
(b) creating one or more relational object maps (ROMs) by:
(i) creating a cross-reference relationship mapping the second RO to the first RO.

13. The apparatus of claim 12 further comprising a hierarchy viewer configured to generate a user-defined report through the series of business rules and process workflows that utilize the relational objects and relational object maps.

14. The apparatus of claim 12 wherein the relational objects and the relational object maps are created at run-time of the master data management system.

15. The apparatus of claim 11 wherein:
the first hierarchy table is a master hierarchy and the second hierarchy is an individual hierarchy;
the master hierarchy comprises a base view of the individual hierarchy; and
the master hierarchy has one or more base-defined hierarchical levels that are shared across the individual hierarchy and any additional individual hierarchies.

16. The apparatus of claim 11 wherein the merged hierarchy comprises a subset of data from the first hierarchy table and a subset of data from the second hierarchy table.

17. An apparatus for merging two hierarchies, comprising:
(a) a relational database management system (RDBMS) executing in a computer system;
(b) a master data management system configured to maintain, as part of a process and framework, a series of business rules and process workflows to manage data that resides in one or more tables in the RDBMS, wherein the data is hierarchical in nature;
(c) a first hierarchy table and a second hierarchy table based on the data, wherein:
(i) the first hierarchy table is defined separately from the second hierarchy table;
(ii) the first hierarchy table and the second hierarchy table define the hierarchical nature of the data in the RDBMS; and
(iii) a placeholder column is defined in the second hierarchy table, wherein the placeholder column maps data in the second hierarchy table to data in the first hierarchy table;
(d) a hierarchy manager, executing in the computer system configured to utilize, via the process and framework, the mapping to create a merged hierarchy in the RDBMS.

18. The apparatus of claim 17 wherein the placeholder column is defined when a schema for the second hierarchy table is defined.

19. The apparatus of claim 17 wherein:
the first hierarchy table is a master hierarchy and the second hierarchy is an individual hierarchy;
the master hierarchy comprises a base view of the individual hierarchy; and
the master hierarchy has one or more base-defined hierarchical levels that are shared across the individual hierarchy and any additional individual hierarchies.

20. The apparatus of claim 17 wherein the merged hierarchy comprises a subset of data from the first hierarchy table and a subset of data from the second hierarchy table.
